(19) United States
(12) Patent Application Publication
(10) Pub. No.: US 2025/0384575 A1
(43) Pub. Date: Dec. 18, 2025

(54) METHOD AND ELECTRONIC DEVICE FOR ESTIMATING A POSE IN AN XR ENVIRONMENT

(71) Applicant: SAMSUNG ELECTRONICS CO., LTD., Suwon-si (KR)

(72) Inventors: Srikanth SRIDHAR, Bengaluru (IN); Sarthak SENGUPTA, Bengaluru (IN); Rajas Jayant JOSHI, Bengaluru (IN); Sujoy SAHA, Bengaluru (IN)

(73) Assignee: SAMSUNG ELECTRONICS CO., LTD., Suwon-si (KR)

(21) Appl. No.: 19/271,176

(22) Filed: Jul. 16, 2025

Related U.S. Application Data
(63) Continuation of application No. PCT/KR2025/008084, filed on Jun. 12, 2025.

(30) Foreign Application Priority Data
Jun. 14, 2024 (IN) 202441046064
Apr. 9, 2025 (IN) 202441046064

(51) Int. Cl. G06T 7/70; G06T 7/20; G06T 17/00; G06V 10/44; G06V 10/74

(52) U.S. Cl. CPC G06T 7/70; G06T 7/20; G06T 17/00; G06V 10/44; G06V 10/761; G06V 2201/07

(57) ABSTRACT

There is provided a method and device for estimating a pose in an XR environment by detecting a transition of an XR device from a first position to a second position, extracting at least one first set of objects from a real-world scene from a list of the plurality of 3D objects at the first position of the XR device, predicting at least one second set of 3D objects, from the list of the plurality of 3D objects, at the second position of the XR device, and estimating the pose at the second position of the XR device, using the at least one first extracted object at the first position and the at least one second predicted object at the second position of the XR device.

### CROSS-REFERENCE TO RELATED APPLICATIONS

This application is a continuation of International Application No. PCT/KR2025/008084, filed on Jun. 12, 2025, which is based on and claims priority to Indian Provisional Patent Application No. 202441046064, filed on Jun. 14, 2024, in the Indian Intellectual Property Office and to Indian Complete patent application No. 202441046064, filed on Apr. 9, 2025, in the Indian Intellectual Property Office, the disclosures of which are incorporated by reference herein in their entireties.

### BACKGROUND

### 1. Field

Embodiments disclosed herein relate to predicting three-dimensional (3D) landmarks, more particularly to methods and electronic device for predicting 3D landmarks for partially visible objects using historical context for Simultaneous Localization and Mapping (SLAM)

### 2. Description of Related Art

Currently, augmented reality (AR)/virtual reality (VR) headset(s) (or device) are emerging as a new breakthrough in the field of augmented reality and making realization of metaverse possible. With its emergence, a variety of use-cases are under-development including providing users with ability to easily navigate, pin tasks, interact with objects, draw in AR, etc. In order to perform these tasks, a user needs to estimate a position and orientation (i.e., pose) of the AR/VR headset(s) with respect to an environment.

Accurate localization and mapping is an important task which is only possible when a SLAM technique can estimate the correct poses. In order to estimate the correct pose of the AR/VR device, 3D landmarks of the environment are visually matched with a camera frame. The AR/VR device is typically used in indoor environments and usually involve fast head motions.

Fast motion of a head or dynamic objects such as people walking in front of a camera or user's hand occluding the camera can lead to loss of visual matches. Another common scenario where this is important is the persistent/multi-session AR. The user can wear the AR/VR device and map the environment and place some virtual objects in the scene. The user then suspends/removes the AR/VR device and might come back later to resume the session. Therefore, during a new AR/VR session, the AR/VR device has to recognize a pre-built scene (re-localization) and retrieve the previously placed AR objects/VR objects. While resuming the AR/VR session, the user might not be at the exact same view-point as during a mapping session.

Hence, the conventional approaches fail to get enough visual matches which will lead to accumulation of drift in the estimated pose in a best case and can lead to complete loss of track of the map. The drift accumulation can lead to the virtual object moving away from its original location thereby leading to a bad user experience. But a change in viewpoint or a change in the scene might lead to the AR/VR device not recognizing the environment and by which the user will not be able to see the virtual objects which were placed earlier.

Many times, specially while using the AR/VR headset(s) in consumer settings, the scenarios mentioned above are very common. The loss of visual matches will lead to accumulation of drift or in the case of suspend/resume scenario lead to loss of tracking of the map.

Typically head mounted devices (HMD) used for indoor scenarios with minimal distinguishing visual features and involve fast motions, out-of-plane rotations, motion blur and dynamic objects which can occlude the camera view. These can cause accumulation of drift in the camera pose estimation or worse even lead to losing track of the camera in the scene.

In addition to the above-mentioned scenarios, the existing method face re-localization failures and delayed re-localization. This is a common problem in the AR/VR headset(s), where the user has to suspend the AR/VR device and can resume later at different viewpoint and time instance. This will result in bad user experience where the virtual object can seem to be moving away from its designated position and can even lead to the object completely disappearing in the case of tracking loss.

Typically, in these kinds of scenarios where the visual matches are unavailable or fewer in number, only an Inertial Measurement Unit (IMU) based pose estimation is used as a stop-gap measure until more visual matches are available. Mostly, existing approaches focus on predicting the pose of a future frame using Kalman filtering approaches (for example). Even if the pose of the future frame is predicted accurately, they fail to establish enough visual matches due to the absence of 3D landmarks. This will lead to accumulation of drift in the estimated pose.

Hence, the AR/VR use cases involve using the AR/VR device in indoor environments (e.g., houses/offices) with minimal distinguishing features. On top of that in the device's (e.g., AR/VR headset) camera perspective there is a lot of out of plane rotation which can lead to most visual SLAM techniques losing tracking. Typically, these kinds of scenarios are handled with the use of the IMU to predict short term motion. But even then, it has been observed that the lack of visual feature matches can lead to accumulation of drift which can also lead to tracking loss.

One other common issue leading to drift accumulation and loss of tracking has been found to be motion blur. The AR/VR headset(s) typically involve very fast motion which causes motion blur. The motion blur can lead to suboptimal visual feature matches leading to degradation of a tracking accuracy.

Typical AR applications involve usage in common indoor (housing/office) like environments where there are various common objects such as table, chair, TV etc. These objects have usually known dimensions. We as humans by just looking at partial views of these objects (such as a chair or table) can predict the entire 3D structure of the scene. A main idea behind one or more aspects of disclosed embodiments herein related to how the electronic device can use this information to predict the unseen 3D scene structure which can then aid in better tracking at a subsequent time instant. By having partial views of these objects and by knowing the current motion estimation, the one or more aspects of disclosed embodiments here can predict the locations of these objects at a future time instant leading to more robust tracking even under the presence of dynamic objects and feature poor scenarios. Instead of operating directly on the images, those aspects operate on the 3D landmark space which also aids in real time on-device performance. As a by-product of the context aware landmark prediction and refinement module, those aspects can also refine descriptors of the existing landmarks which helps in obtaining feature matches even in the presence of extreme motion blur.

FIGS. 1A and 1s example diagram 100a, FIG. 1B and its example diagram 100b, and FIG. 1C and its example diagram 100c illustrate the simultaneous localization and mapping (SLAM), according to related arts. As illustrated in FIG. 1A, the SLAM is demonstrated, marked points in the image are feature points, and in 3D space are landmarks. The tracks are shown as being drawn in a static environment, while the camera is moving.

FIG. 1B illustrates the pose in the 3D space, wherein the pose of a co-ordinate frame can be described with respect to another co-ordinate frame. The pose, as illustrated, has a translational component, and a rotational component. The translational component moves the object from one position to another without changing its orientation. The rotational component spins the object around a point, changing its orientation but not its position. For example, if a square is rotated around its center, the corners of the square move along a circular arc, but the size and shape of the square remain unchanged. FIG. 1C illustrates the feature tracking and camera pose estimation.

FIG. 2 is an example diagram 200 illustrating neural radiance fields (NeRF), according to related art. View Synthesis is the task of creating new views of the scene from multiple pictures of the scene. Early methods focused on either interpolating between corresponding pixels or rays from two different views. Recently, Deep Learning methods have made tremendous improvements and have improved the quality of the results. The problem is challenging as a model has to learn to accurately synthesize new views-including the 3D structure, materials and illumination from a small set of reference images

Neural Radiance Fields (NeRF) is one of the commonly used approaches for novel view synthesis. It is a simple fully connected network trained to reproduce input views of a single scene using a rendering loss. The network directly maps from spatial location and viewing direction (5D input) to color and opacity (4D output). The notations “a-d” 5D input (x,y,z,θ,ϕ) is encoded and passed through a neural network. The neural network color and density for each point in the scene. A Volume rendering is used to accumulate colors and densities along rays passing through the scene, so as to generate a final pixel color. A rendering loss (e.g., mean squared error between predicted and ground truth image) is used to update the network during training.

FIG. 3 is an example diagram 300 depicting the epipolar geometry, according to related art. To calculate the depth of a point, the system needs more than one image. This is because from a single view, the camera loses a depth information when a 3D point is projected to 2D. The process of finding the depth of a point is called triangulation. By observing a point from two different viewpoints, the depth of the point with respect to one of the cameras can be estimated.

Given two viewpoints/cameras with known geometry, as mentioned to find the depth of the point (X), the system needs to establish its projection in the second camera (CR). The Epipolar geometry describes the geometric relation between two camera pairs. It states that the projection of 3D point (X) falls on a line in the right camera image. This reduces the search area from 2D to 1D.

The projection of the point X onto right camera image is called as the Epipolar line. The point of intersection of line connecting the two camera centers (OL-OR) with the corresponding camera is called as the Epipoles (eL and eR). The plane connecting the points OL, X, OR is called as the Epipolar plane. Therefore, epipolar geometry is used for reconstructing the 3D points/Landmarks (depth) from two viewpoints with known poses.

Hence, embodiments herein use the presence of common household objects to predict new 3D landmarks at previously unseen locations using historical context. These new 3D landmarks are then used to obtain new visual feature matches thereby estimating a more accurate pose of the camera.

The information disclosed in this background of the disclosure section is only for enhancement of understanding of the general background of the invention and should not be taken as an acknowledgement or any form of suggestion that this information forms the prior art already known to a person skilled in the art.

### SUMMARY

A principal object of the embodiments herein related to methods and systems for enhancing pose estimation for an XR device.

Objects of embodiments herein are to predict 3D landmarks for partially visible objects using historical context for SLAM.

Objects of embodiments herein are to detect a transition of the XR device from a first position to a second position.

Objects of embodiments herein are to extract at least one first set of objects from a real-world scene from the list of the plurality of 3D objects at the first position of the XR device.

Objects of embodiments herein are to predict at least one second set of 3D objects, from the list of the plurality of 3D objects, at the second position of the XR device.

Objects of embodiments herein are to estimate the pose at the second position of the XR device, using the at least one first extracted object at the first position and the at least one second predicted object at the second position of the XR device.

Objects of embodiments herein are to receive a first image frame of a real-world scene around an XR device using at least one senor of the XR device.

Objects of embodiments herein are to detect a motion of the XR device subsequent to receiving the first image frame using the at least one sensor of the XR device.

Objects of embodiments herein are to identify at least one 3D landmark of objects present in the first image frame of the real-world scene in response to the detected motion.

Objects of embodiments herein are to predict at least one new 3D landmarks of objects present in a second image frame of the real world scene, by correlating the at least one identified 3D landmarks and the detected motion with a memory.

Objects of embodiments herein are to predict at least one new 3D landmarks of objects present in a second image frame of the real world scene, by correlating the at least one identified 3D landmarks and the detected motion with a memory.

Objects of embodiments herein make the relocalization more robust and faster. The user can resume the session by looking at the scene from viewpoints which are different from where the user suspended the earlier session.

There is provided a method for estimating a pose in an Extended reality (XR) environment, the method including: obtaining, by an XR device, a list of a plurality of three dimensional (3D) objects relevant to each position of the XR device; detecting, by the XR device, a transition of the XR device from a first position to a second position, the first position and the second position being positions of the each position of the XR device; extracting, by the XR device, at least one first set of objects from a real-world scene from the list of the plurality of 3D objects and at the first position of the XR device; predicting, by the XR device, at least one second set of 3D objects, from the list of the plurality of 3D objects, at the second position of the XR device; and estimating, by the XR device, the pose, which is at the second position of the XR device, using the at least one first extracted object at the first position and the at least one second predicted object at the second position of the XR device.

Estimating, by the XR device, the pose at the second position of the XR device, using the at least one first extracted object at the first position and the at least one second predicted object at the second position of the XR device may include: identifying positions, including at least one previously visited position, in reference to the first position of the XR device from a memory, the at least one previously visited position being of the each position of the XR device; computing an embedding vector for each of the identified positions, including the at least one previously visited position, by accumulating the visual information at a particular position; aggregating the computed embedding vectors from each of the identified positions; generating an image for the second position of the XR device using the aggregated information; generating at least one 3D object at the second position of the XR device by correlating the generated image with the memory; and estimating the pose of the second position of the XR device using the generated 3D object.

Estimating, by the XR device, the pose at the second position of the XR device, using the at least one first extracted object at the first position and the at least one second predicted object at the second position of the XR device may include: generating an image for the second position using accumulated information of reference views; detecting at least one visual feature from the generated image; extracting at least one descriptor associated with the at least one detected visual feature; matching the at least one detected visual feature along with at least one extracted descriptor of the at least one second predicted object at the second position of the XR device with a memory; and estimating the pose at the second position of the XR device.

Generating the image for the second position using the accumulated information of the reference views may include: aggregating patches along an epipolar line of a target location at the first position; using a transformer to aggregate information along the epipolar line, wherein the transformer is trained to attend along the epipolar line; generating an embedding vector of the aggregated epipolar patches; accumulating information along the reference views; and generating the image for the second position using the accumulated information of the reference views.

The transformer may aggregate the information across the reference views.

Obtaining, by the XR device, the list of the plurality of 3D objects relevant to the each position of the XR device may include: detecting at least one location of a 3D object of the plurality of 3D objects; matching the 3D object across the each position of the XR device; mapping the plurality of 3D objects relevant to each position of the XR device using matched locations; and obtaining the list of the plurality of 3D objects relevant to the each position of the XR device based on the mapping.

Obtaining, by the XR device, the list of the plurality of 3D objects relevant to the each position of the XR device may include: determining, by the XR device, a plurality of positions associated with the XR device in a XR scene, the plurality of positions comprising the first position and the second position; determining, by the XR device, a plurality of three dimensional (3D) objects in a real-world scene; and obtaining, by the XR device, the list of the plurality of 3D objects relevant to the each position of the XR device.

At least some of the plurality of positions may be previously visited positions by the XR device in a same scene of the real-world scene.

The at least one second set of 3D objects may be at least one partially visible second set of 3D objects in an XR scene of the real-world scene, and the at least one second set of 3D objects, from the list of the plurality of 3D objects, at the second position of the XR device may be predicted by the XR device based on the XR device determining that the XR device is not able to view the at least one second set of 3D objects in the XR scene.

The plurality of positions associated with the XR device in the XR scene may be determined by using at least one sensor, and the objects from the real-world scene may be determined by using the at least one sensor.

There is provided a method for estimating a pose in an Extended reality (XR) environment by an XR device, including: receiving a first image frame of a real-world scene around an XR device using at least one sensor of the XR device; detecting a motion of the XR device subsequent to receiving the first image frame using the at least one sensor of the XR device; identifying, in response to the detected motion, at least one three dimensional (3D) landmark of objects present in the first image frame of the real-world scene; and predicting at least one new 3D landmark of objects present in a second image frame of the real world scene, by correlating the identified at least one 3D landmark and the detected motion with a memory.

The method may further include estimating the pose of the XR device corresponding to the second image frame using both the identified at least one 3D landmark and the predicted at least one new 3D landmark.

The memory may store information representing the one or more previously identified objects and corresponding 3D landmarks of objects, including the identified at least one 3D landmark, in the real-world scene.

There is provided an XR device, including: a processor; a memory; and an XR content controller, coupled with the processor and the memory, configured to: obtain a list of a plurality of three dimensional (3D) objects relevant to each position of the XR device; detect a transition of the XR device from a first position to a second position, the first position and the second position being positions of the each position of the XR device; extract at least one first set of objects from a real-world scene from the list of the plurality of 3D objects and at the first position of the XR device (400); and predict at least one second set of 3D objects, from the list of the plurality of 3D objects, at the second position of the XR device; and estimate the pose, which is at the second position of the XR device, using the at least one first extracted object at the first position and the at least one second predicted object at the second position of the XR device.

There is provided an XR device, including: a processor; a memory; and an XR content controller, coupled with the processor and the memory, configured to: receive a first image frame of a real-world scene around an XR device using at least one sensor device of the XR device; detect a motion of the XR device subsequent to receiving the first image frame using at least one inertial sensor of the XR device; identify, in response to the detected motion, at least one three dimensional (3D) landmark of objects present in the first image frame of the real-world scene; and predict at least one new 3D landmarks of objects present in a second image frame of the real world scene, by correlating the identified at least one 3D landmark and the detected motion with a memory.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1A, FIG. 1B, and FIG. 1C are example diagrams illustrating the simultaneous localization and mapping (SLAM);

FIG. 2 is an example diagram illustrating the neural radiance fields (NeRF);

FIG. 3 is an example diagram depicting the epipolar geometry;

FIG. 4 shows various hardware components of the XR device, according to one or more embodiments as disclosed herein;

FIG. 5 shows various hardware components of an XR content controller included in the XR device, according to one or more embodiments as disclosed herein;

FIG. 6 and FIG. 7 are flow charts illustrating a method for estimating a pose in an XR environment by the XR device, according to one or more embodiments as disclosed herein;

FIG. 8 is an example diagram illustrating a method for predicting 3D landmarks for partially visible objects using historical context for SLM, according to one or more embodiments as disclosed herein;

FIG. 9 is an example diagram illustrating an operation of a household object detector included in the XR content controller using SLAM, according to one or more embodiments as disclosed herein;

FIG. 10 is an example diagram illustrating an operation of an object feature aggregator with an object view generator included in the XR content controller, according to one or more embodiments as disclosed herein;

FIG. 11 is an example diagram illustrating the epipolar line-based feature aggregation, according to one or more embodiments as disclosed herein;

FIG. 12 is an example diagram illustrating the epipolar line-based feature aggregation in detailed architecture, according to one or more embodiments as disclosed herein;

FIG. 13 is an example diagram illustrating the object view feature aggregation in detailed architecture, according to one or more embodiments as disclosed herein;

FIG. 14 is an example diagram illustrating the view feature extractor along the 3D landmark generator, according to one or more embodiments as disclosed herein;

FIG. 15 is an example diagram illustrating re-localization in suspend/resume scenario using an AR headset, according to one or more embodiments as disclosed herein; and

FIG. 16 is an example diagram illustrating scene occlusion, according to one or more embodiments as disclosed herein.

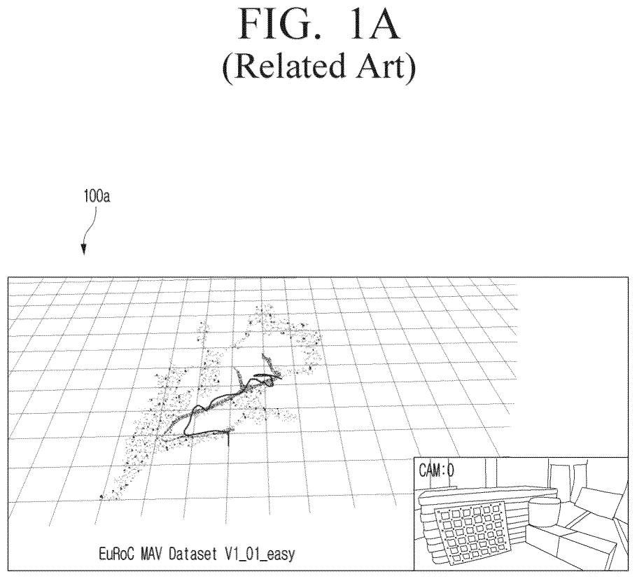

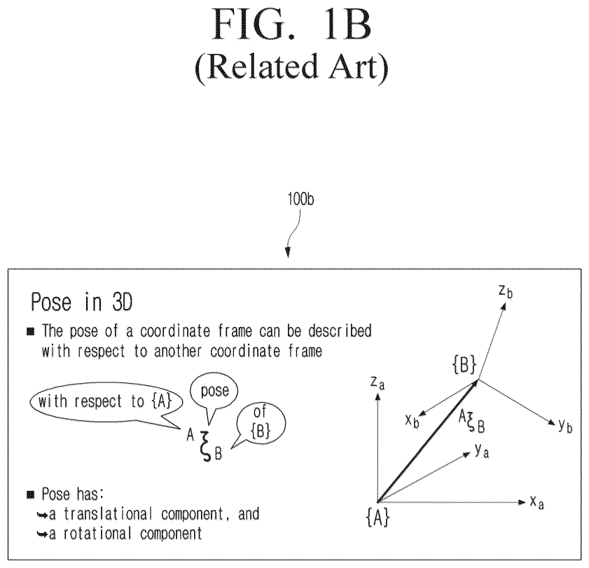

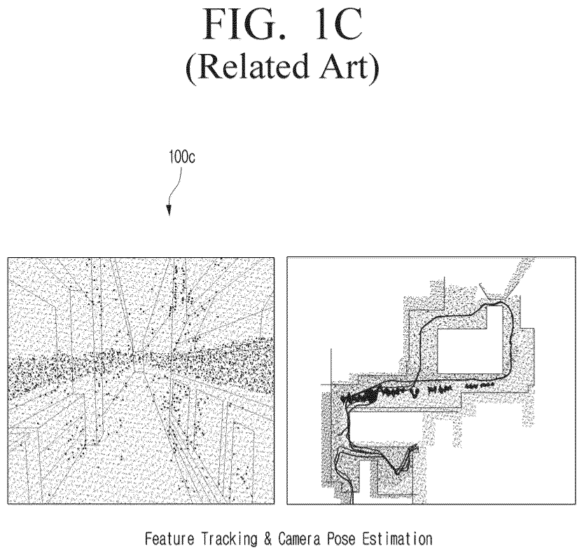

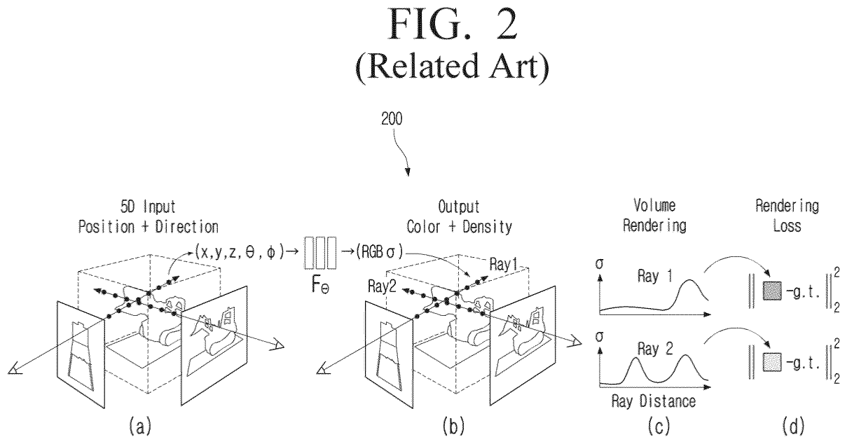

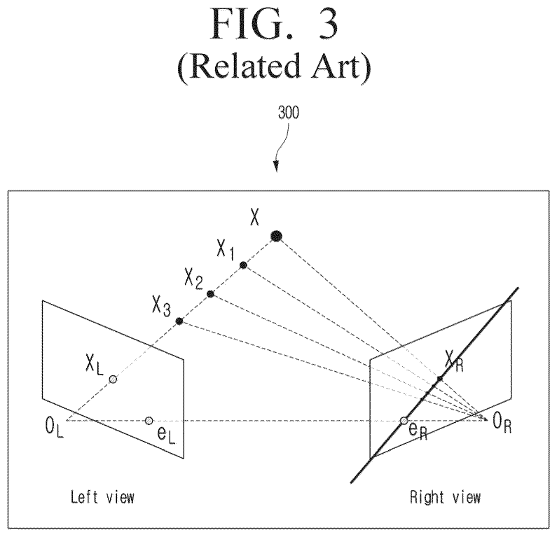

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve a method for estimating a pose in an XR environment. The method includes obtaining, by the XR device, a list of a plurality of three dimensional (3D) objects relevant to each position of the XR device. Further, the method includes detecting, by the XR device, a transition of the XR device from a first position to a second position. Further, the method includes extracting, by the XR device, at least one first set of objects from a real-world scene from the list of the plurality of 3D objects at the first position of the XR device. Further, the method includes predicting, by the XR device, at least one second set of 3D objects, from the list of the plurality of 3D objects, at the second position of the XR device. Further, the method includes estimating, by the XR device, the pose at the second position of the XR device, using the at least one first extracted object at the first position and the at least one second predicted object at the second position of the XR device.

One or more embodiments are used to predict new 3D landmarks for partially visible objects using historical context for SLAM. Embodiments herein provide a method to generate new 3D landmarks for an object at a viewpoint which will be observed at future timestamp. These newly generated 3D landmarks are then used to obtain visual matches for the incoming frame to estimate the pose of the camera in an accurate manner.

Embodiments herein make the re-localization more robust and faster. The user can resume the session by looking at the scene from viewpoints which are different from where the user suspended the earlier session. And embodiments herein make the tracking in XR device more robust to occlusion from dynamic objects such as people walking in front the camera or hands blocking majority of the camera field of view.

One or more embodiments herein may not consider the whole 3D scene, and instead consider only household objects, thereby reducing latency for estimating the pose in the XR environment. The embodiments may also not only detect/segments common objects but also generate the novel 3D points and descriptors of these objects which can then be used, and according to one or more embodiments are used, for future tracking while estimating the pose in the XR environment.

One or more embodiments are used to generate new 3D landmarks for the object at a viewpoint which will be observed at future timestamp. The newly generated 3D landmarks are then used to obtain visual matches for the incoming frame to estimate the pose of the camera.

One or more embodiments are used to ensure that there are good number of visual feature matches even in the presence of fast motion, dynamic objects occluding the camera. One or more embodiments are used to predict new 3D landmarks and their corresponding descriptors of common indoor objects at a future time instance. These predicted 3D landmarks and their descriptors are then used in the front-end of a visual SLAM framework to establish new feature matches for accurate pose estimation. The newly predicted landmarks ensures that there is enough visual feature matches during all kinds of common user scenarios. Thus, the calculated pose has minimal drift and will eliminate track loss without adding any additional latency. This results in enhancing the user experience.

One or more embodiments are used with any HMD/XR/AR/VR device which has the minimum basic sensors such as camera and IMU. One or more embodiments are used as a plug and play feature on top of any existing visual SLAM frameworks thus ensuring compatibility and make it future-proof without adding any additional latency to the camera tracking thread.

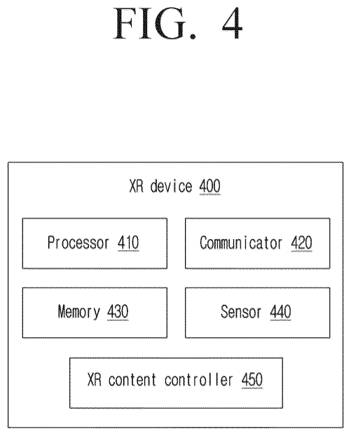

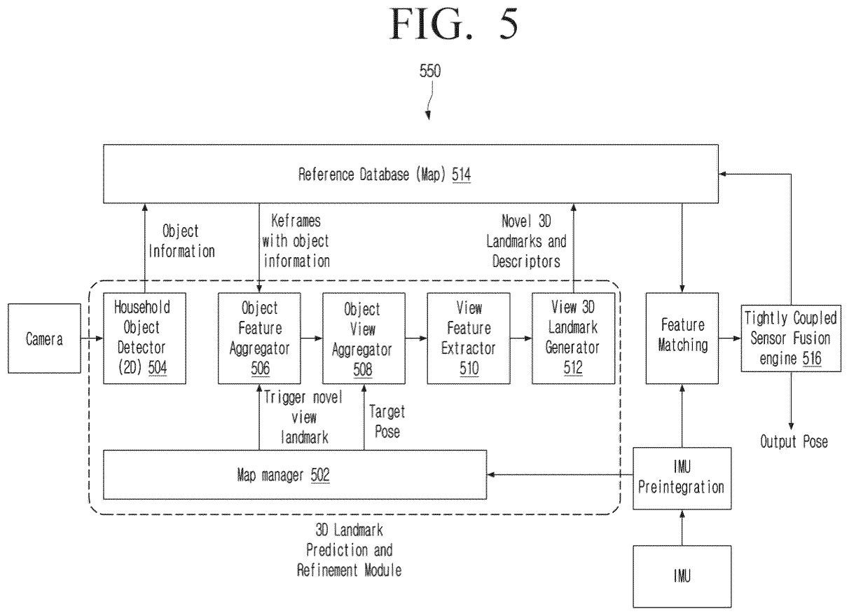

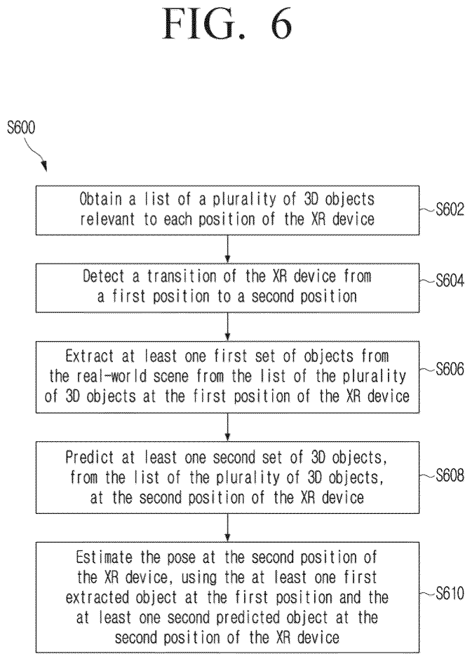

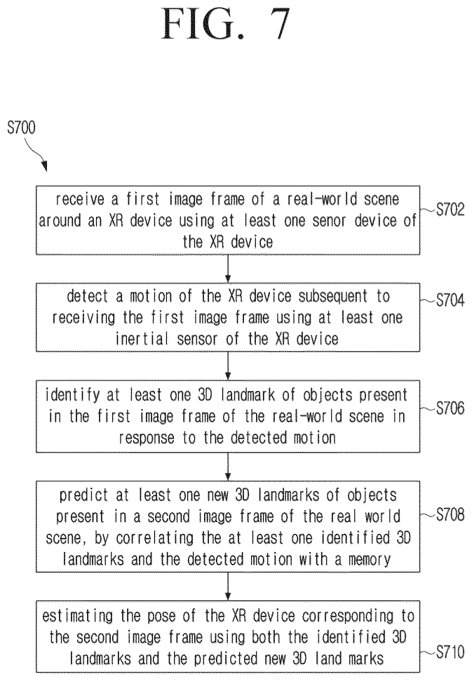

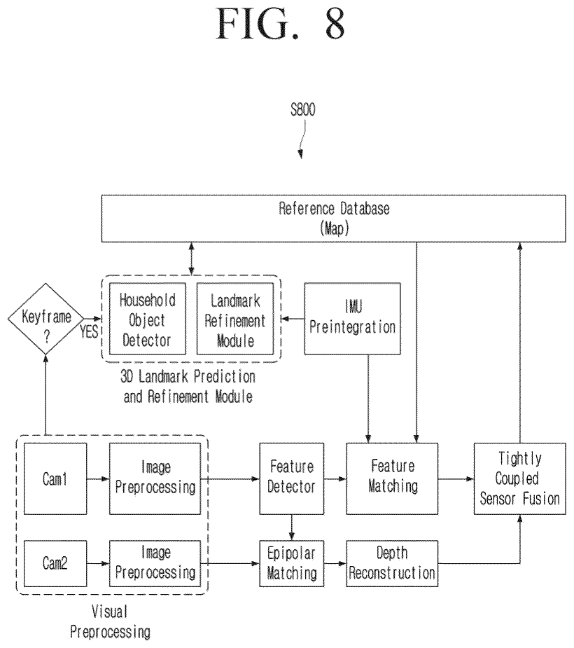

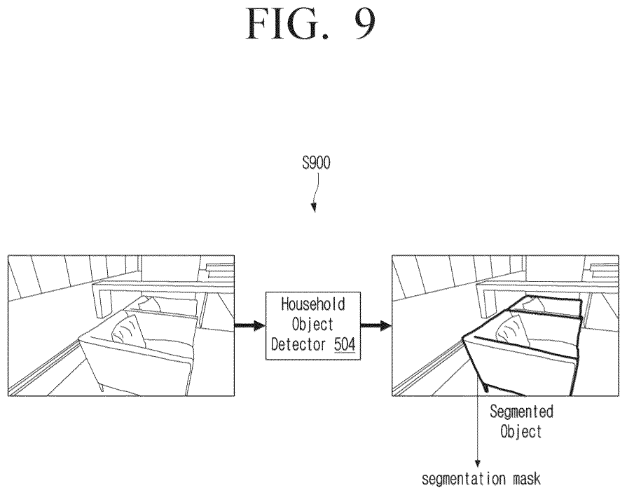

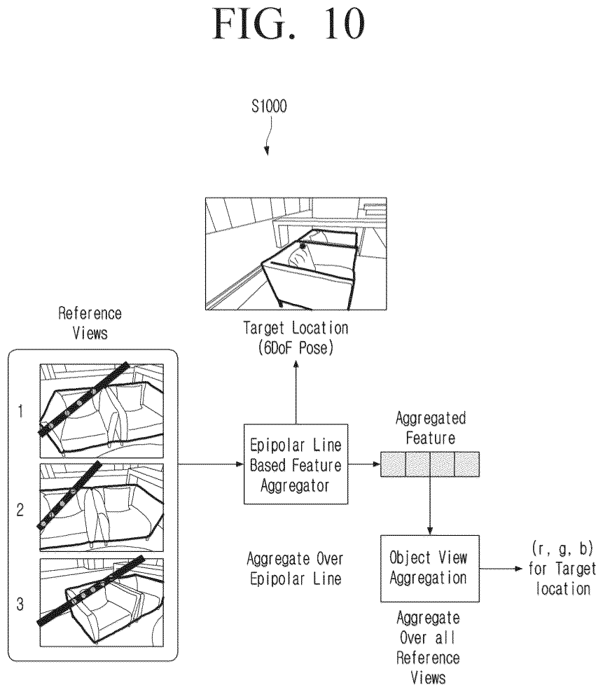

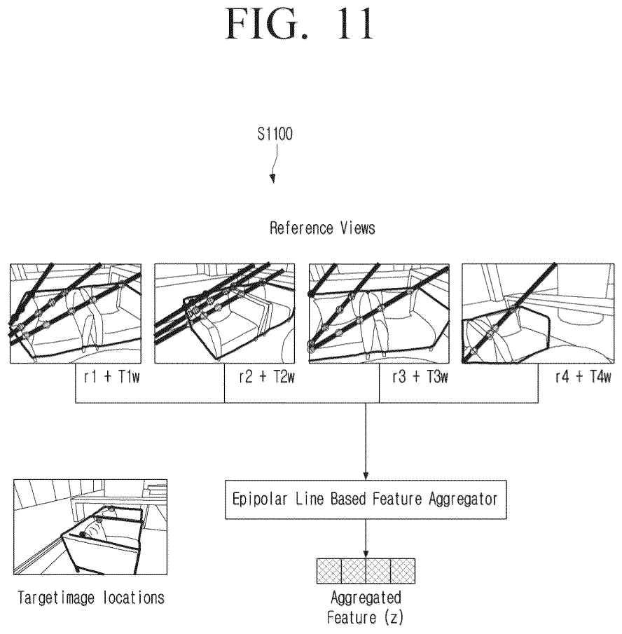

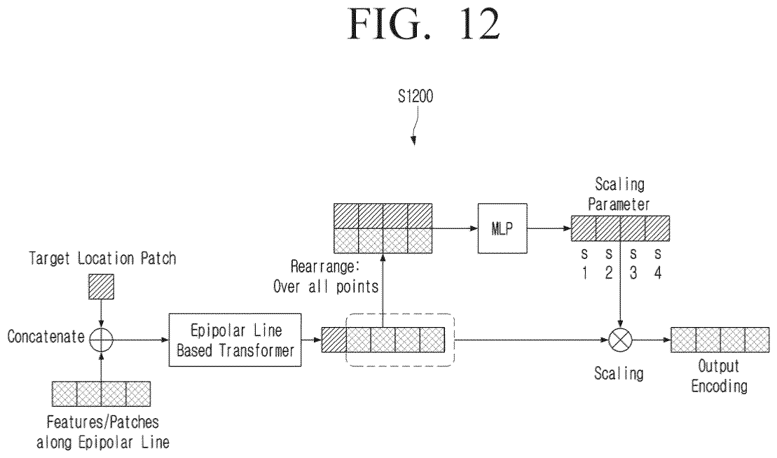

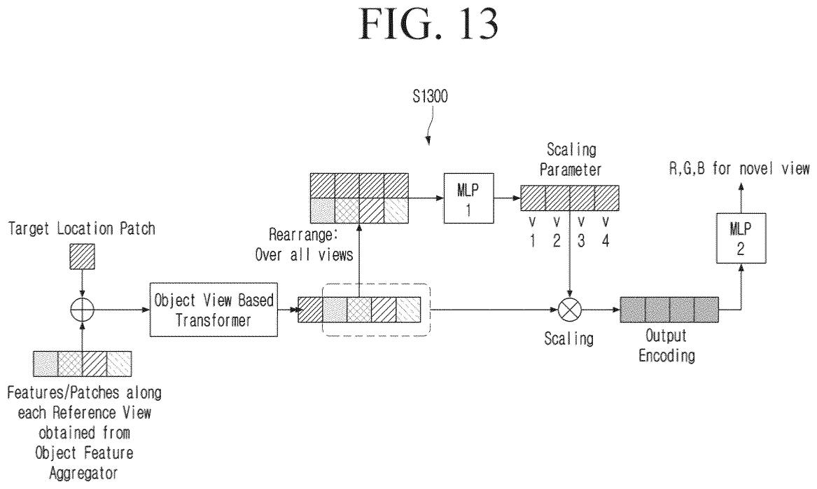

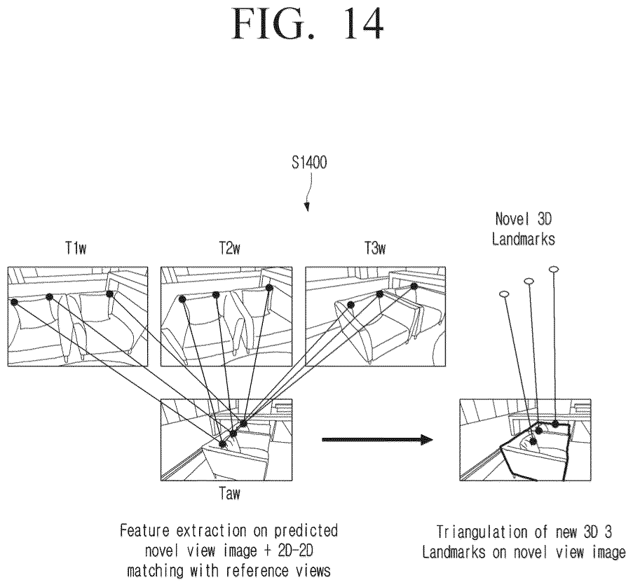

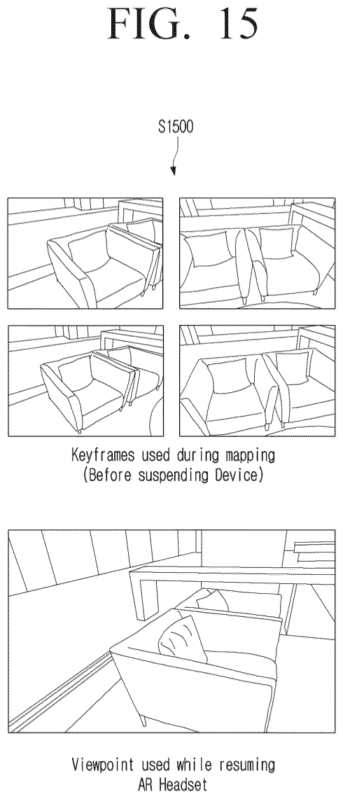

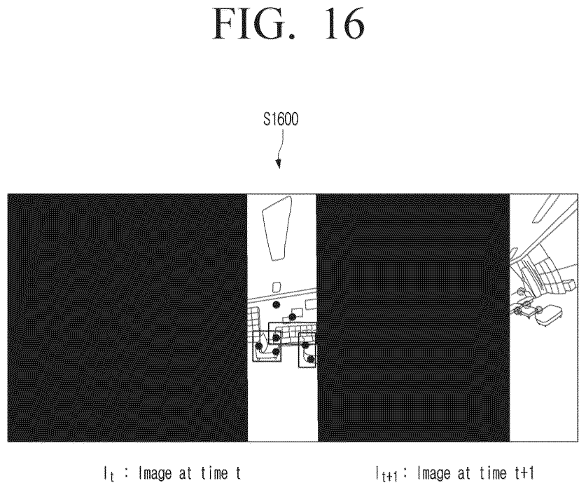

Referring now to the drawings, and more particularly to FIG. 4, FIG. 5, FIG. 6, FIG. 7, FIG. 8, FIG. 9, FIG. 10, FIG. 11, FIG. 12, FIG. 13, FIG. 14, FIG. 15, and FIG. 16, similar reference characters denote corresponding features consistently throughout the figures.

FIG. 4 shows various hardware components of the XR device 400, according to one or more embodiments as disclosed herein. The XR device 400 can be, for example, but not limited to, a VR device, an AR device, an HMD device, or the like. The XR device 400 can also be, for example, but not limited to a laptop, a desktop computer, a notebook, a Device-to-Device (D2D) device, a vehicle to everything (V2X) device, a smartphone, a foldable phone, a smart TV, a tablet, an immersive device, and an internet of things (IoT) device.

According to one or more embodiments, the XR device 400 includes a processor 410, a communicator 420, a memory 430, a sensor 440 and an XR content controller 450. The processor 410 is coupled with the communicator 420, the memory 430, the sensor 440 and the XR content controller 450.

According to one or more embodiments, the XR content controller 450 obtain a list of a plurality of 3D objects relevant to each position of the XR device 400. According to one or more embodiments, the XR content controller 450 detects at least one location of the plurality of 3D objects. Further, the XR content controller 450 matches the detected 3D object across each position of the XR device 400. Further, the XR content controller 450 maps the plurality of 3D objects relevant to each position of the XR device 400 using the matched locations. Further, the XR content controller 450 obtains the list of the plurality of 3D objects relevant to each position of the XR device 400 based on the mapping.

According to one or more embodiments, the XR content controller 450 determines the plurality of positions associated with the XR device 400 in a XR scene. Further, the XR content controller 450 determines a plurality of three dimensional (3D) objects in a real-world scene. Further, the XR content controller 450 obtains the list of the plurality of 3D objects relevant to each position of the XR device 400.

The plurality of positions associated with the XR device 400 in the XR scene is determined by using at least one sensor 440. The plurality of 3D objects in the real-world scene is determined by using the at least one sensor 440. The plurality of positions are previously visited positions by the XR device in the same scene.

Further, the XR content controller 450 detects a transition of the XR device 400 from a first position to a second position. Further, the XR content controller 450 extracts at least one first set of objects from the real-world scene from the list of the plurality of 3D objects at the first position of the XR device 400. Further, the XR content controller 450 predicts at least one second set of 3D objects, from the list of the plurality of 3D objects, at the second position of the XR device 400. The XR content controller 450 estimates the pose at the second position of the XR device 400, using the at least one first extracted object at the first position and the at least one second predicted object at the second position of the XR device 400.

According to one or more embodiments, the XR content controller 450 aggregates all the patches along an epipolar line of a target location at the first position. The XR content controller 450 uses a transformer to aggregate information along the epipolar line. The transformer learns to attend along the epipolar line. Further, the XR content controller 450 generates an embedding vector of the aggregated epipolar patches. Further, the XR content controller 450 accumulates information along all the reference views, where the transformer is used to aggregate the information across the reference views. Further, the XR content controller 450 generates an image for the second position using the accumulated information of all the reference views. Further, the XR content controller 450 detects at least one visual feature from the generated image. Further, the XR content controller 450 extracts at least one descriptor associated with the at least one detected visual feature. Further, the XR content controller 450 matches at least one detected visual feature along with at least one extracted descriptor of the at least one second predicted object at the second position of the XR device 400 with the memory 430. Further, the XR content controller 450 estimates the pose at the second position of the XR device 400.

The descriptor refers to a representation or set of features derived from specific points or regions in an image or video stream in the XR scene. The descriptor encodes important information about the visual features (such as corners, edges, or textures) of the XR scene, making it possible to recognize and track these features across multiple frames or views. The descriptor can be, for example, but not limited to a Scale-Invariant Feature Transform (SIFT) type descriptor, a Speeded-Up Robust Features (SURF) type descriptor, and an Oriented FAST and Rotated BRIEF (ORB) type descriptor.

According to one or more embodiments, the visual features are first identified within the XR scene. The visual features are often distinctive points (e.g., key points like corners, blobs, or edges) that stand out from the surrounding environment. These could be based on certain attributes such as color contrast, texture patterns, or geometric shapes. Once the visual features are detected, the descriptor is generated. The descriptor is essentially unique identifiers for the detected features and capture the visual characteristics of each point or XR region. Further, the descriptor is then used to compare and match the features across different frames or views. By matching features between a reference view (such as an initial image or frame) and subsequent views (e.g., from a live camera feed), the XR device 400 can estimate the relative position and orientation (pose) of the camera or objects in the XR environment.

In short, the descriptors in XR pose estimation help in identifying, matching, and tracking visual features across multiple views, which is essential for determining the precise spatial relationship between the camera (or user) and the environment.

According to one or more embodiments, the XR content controller 450 identifies the at least one previously visited positions in reference to the first position of the XR device 550 from the memory 430. Further, the XR content controller 450 computes the embedding vector for each of the identified positions by accumulating the visual information at a particular position. Further, the XR content controller 450 aggregates the computed embedding vectors from each of the identified positions. Further, the XR content controller 450 generates the image for the second position of the XR device 400 using the aggregated information. Further, the XR content controller 450 generates at least one 3D object at the second position of the XR device 400 by correlating the generated image with the memory 430. Further, the XR content controller 450 estimates the pose of the second position of the XR device 400 using the generated 3D object.

The at least one second set of 3D objects is at least one partially visible second set of 3D objects in the XR scene. The at least one second set of 3D objects, from the list of the plurality of 3D objects, at the second position of the XR device 400 is predicted when the XR device 400 is not able to view the at least one second set of 3D objects in the XR scene.

According to one or more embodiments, the XR content controller 450 receives a first image frame of a real-world scene around the XR device 400 using at least one senor device 440 of the XR device 400. Further, the XR content controller 450 detects a motion of the XR device 400 subsequent to receiving the first image frame using at least one inertial sensor of the XR device 400. Further, the XR content controller 450 identifies at least one 3D landmark of objects present in the first image frame of the real-world scene in response to the detected motion. Further, the XR content controller 450 predicts at least one new 3D landmarks of objects present in a second image frame of the real world scene, by correlating the at least one identified 3D landmarks and the detected motion with the memory 430. The memory 430 includes one or more previously identified objects and corresponding 3D landmarks of objects in the real-world scene. Further, the XR content controller 450 estimates the pose of the XR device 400 corresponding to the second image frame using both the identified 3D landmarks and the predicted new 3D landmarks.

The XR content controller 450 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 410 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 410 may include multiple cores and is configured to execute the instructions stored in the memory 430.

Further, the processor 410 is configured to execute instructions stored in the memory 430 and to perform various processes. The communicator 420 is configured for communicating internally between internal hardware components and with external devices via one or more networks. The memory 430 also stores instructions to be executed by the processor 410. The memory 430 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 430 may, in some examples, be considered a non-transitory storage medium. The term “non-transitory” may indicate that the storage medium is not embodied in a carrier wave or a propagated signal. However, the term “non-transitory” should not be interpreted that the memory 430 is non-movable. In certain examples, a non-transitory storage medium may store data that can, over time, change (e.g., in Random Access Memory (RAM) or cache).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/or may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 4 shows various hardware components of the XR device 400 but it is to be understood that other embodiments are not limited thereon. In other embodiments, the XR device 400 may include less or more number of components. Further, the labels or names of the components are used only for illustrative purposes and does not limit the scope of the invention. One or more components can be combined together to perform the same or substantially similar function in the XR device 400.

FIG. 5 shows various hardware components of the XR content controller 450 included in the XR device 400, according to one or more embodiments as disclosed herein. According to one or more embodiments, the XR content controller 450 includes a map manager 502, a household object detector 504, an object feature aggregator 506, an object view aggregator 508, a view feature extractor 510, a view 3D landmark generator 512 and a tightly coupled sensor fusion engine 516. The map manager 502, the household object detector 504, the object feature aggregator 506, the object view aggregator 508, the view feature extractor 510, the view 3D landmark generator 512 and the tightly coupled sensor fusion engine 516 are communicated with each other.

The map manager 502 acts as the high level class which controls all the modules (e.g., the household object detector 504, the object feature aggregator 506, the object view aggregator 508, the view feature extractor 510 and the view 3D landmark generator 512) related to landmark generation. The map manager 502 selects the reference images to be used and the frequency at which the other modules have to run. The map manager 502 also provides the target location for which the landmarks need to be generated.

The map manager 502 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The household object detector 504 works in the form of 2D. The The household object detector 504 detects the locations of the specific indoor objects it was trained upon. The The household object detector 504 is only run on frames selected by the map manager 502. The example operation of the household object detector 504 is explained in FIG. 9.

The household object detector 504 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Instead of processing each image completely, the object feature aggregator 506 focuses on only the object of interest and also focuses on only regions which influence the target pixel. These are located along the epipolar line. Therefore, the the object feature aggregator 506 uses a transformer to aggregate information along the epipolar line. The transformer learns to attend along the epipolar line.

The object feature aggregator 506 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The object view aggregator 508 focuses on aggregation of information influencing the target pixel inside the image. The object view aggregator 508 focuses on accumulating the information along all the reference views. The transformer is used to aggregate the information across reference views. Therefore, this transformer uses attention across views. The example operation of the object feature aggregator 506 with the object view generator 508 is explained in FIG. 10.

The object view aggregator 508 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

By using the view feature extractor 510, on the generated novel view image for the target pose, new visual features are detected and their corresponding descriptors are extracted. The view feature extractor 510 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The view 3D landmark generator 512 first matches the newly detected features on the novel image with the reference images. The view 3D landmark generator 512 uses more than one reference image for ensuring robustness and accuracy. The view 3D landmark generator 512 then triangulates new 3D landmarks from the 2D-2D matches. The view 3D landmark generator 512 also assigns the descriptors and 2D association to these landmarks. The example operation of the view feature extractor 510 and the 3D landmark generator 512 are explained in FIG. 14.

The view 3D landmark generator 512 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the tightly coupled sensor fusion engine 516 is responsible for performing the bundle adjustment after feature matching process from the sensor. The bundle adjustment is the process of optimizing the locations of the 3D landmarks, keyframe poses and the IMU parameters while reducing the reprojection error. The tightly coupled sensor fusion engine 516 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The XR content controller 450 also includes a reference database 514 consists of all the map related information. The reference database 514 stores the keyframes, 2D feature locations, 3D landmarks and descriptors. The reference database 514 also stores the 3D-2D associations. These are the 2D locations on each keyframe from which the landmarks are visible.

Although FIG. 8 shows various hardware components of the XR content controller 450 but it is to be understood that other embodiments are not limited thereon. In other embodiments, the XR content controller 450 may include less or more number of components. Further, the labels or names of the components are used only for illustrative purposes and does not limit the scope of the invention. One or more components can be combined together to perform the same or substantially similar function in the XR content controller 450.

FIG. 6 and FIG. 7 represent respective flow charts S600 and S700 illustrating a method for estimating a pose in an XR environment by the XR device 400, according to one or more embodiments as disclosed herein.

As shown in FIG. 6, the operations S602, S604, S606, S60, and S610 are handled by the XR content controller 450. At S602, the method includes obtaining the list of the plurality of 3D objects relevant to each position of the XR device 400. At S604, the method includes detecting the transition of the XR device 400 from the first position to the second position. At S606, the method includes extracting the at least one first set of objects from the real-world scene from the list of the plurality of 3D objects at the first position of the XR device 400.

At S608, the method includes predicting the at least one second set of 3D objects, from the list of the plurality of 3D objects, at the second position of the XR device. At S610, the method includes estimating the pose at the second position of the XR device 400, using the at least one first extracted object at the first position and the at least one second predicted object at the second position of the XR device 400.

As shown in FIG. 7, the operations S702, S704, S706, S708, and S710 are handled by the XR content controller 450. At S702, the method includes receiving the first image frame of a real-world scene around the XR device 400 using at least one senor 440 of the XR device 400. At S704, the method includes detecting the motion of the XR device 400 subsequent to receiving the first image frame using the at least one sensor 440.

At S706, the method includes identifying the at least one 3D landmark of objects present in the first image frame of the real-world scene in response to the detected motion. At S708, the method includes predicting at least one new 3D landmarks of objects present in a second image frame of the real world scene, by correlating the at least one identified 3D landmarks and the detected motion with the memory 430.

At S710, the method includes estimating the pose of the XR device 400 corresponding to the second image frame using both the identified 3D landmarks and the predicted new 3D landmarks.

FIG. 8 is an example diagram S800 illustrating a method for predicting 3D landmarks for partially visible objects using historical context for the SLAM, according to one or more embodiments as disclosed herein.

The sensor data (e.g., access stereo camera data) is obtained from the camera. The camera images are pre-processed to remove the noise. The IMU data is accessed and pre-processed to remove the noise. The method involves performing the IMU pre-integration to obtain incremental device pose at camera timestamp.

Further, the method includes performing the household object detection. For a given future target location (based on the trajectory followed so far), the method includes selecting the few reference view points and their corresponding poses. The reference view will have the mask of the segmented object.

Further, the method provide these as input to the object feature aggregator 506. For each reference view, the object feature aggregator 506 aggregates all the patches along the epipolar line of the target location. An embedding vector of the aggregated epipolar patches is then generated. The object feature aggregator 506 then aggregates the information from the view feature extractor 510 along all the reference views to generate the colour and opacity information for the target location.

The view feature extractor 510 then extracts new features on the generated image from the view 3D landmark generator 512 and then matches it with all the other reference views. Based on the feature matching, the view 3D landmark generator 512 triangulate new 3D Landmarks and update the associations of these new landmarks with all the other keyframes. The view 3D landmark generator 512 also assigns the descriptor for the novel view image. The feature matching uses the newly predicted landmarks and their descriptors for feature matching and obtain 3D-2D associations. The local map bundle adjustment (or pose refinement) uses the updated 3D-2D associations and reduces the reprojection error by optimizing for the keyframe camera poses, 3D landmark positions and IMU constraints.

FIG. 9 is an example diagram S900 illustrating an operation of the household object detector 504 using the SLAM, according to one or more embodiments as disclosed herein. The household object detector 504 is run on each SLAM keyframe. The SLAM keyframe is a sampled frame from a SLAM framework. For removing redundancy, the SLAM uses only subset of frames. The household object detector 504 uses an object segmentation model (not shown), trained only on selected list of household objects such as sofa, table, chair etc. The household object detector 504 outputs a segmentation mask of the object as output.

FIG. 10 is an example diagram S1000 illustrating the operations of the object feature aggregator 506 with the object view generator 508, according to one or more embodiments as disclosed herein. For a given target location/view point, image patches of the object are aggregated along the epipolar line on few selected reference views in the SLAM database (map). The Epipolar line-based object feature aggregator (for example) is a transformer module which uses attention mechanism. Due to which there is local attention along the epipolar line. The second transformer (e.g., object view aggregator 508) aggregates the object information across all the reference views (Cross Attention) and then predicts the pixel information (R, G, B value) at target location.

FIG. 11 is an example diagram (S1100 illustrating the epipolar line-based feature aggregation, according to one or more embodiments as disclosed herein. As illustrated in FIG. 11, the image patch for each target location is illustrated. Epipolar line for each target location, segmented object for landmark generation with DoF pose of the image write respect to world reference is illustrated.

FIG. 12 is an example diagram (S1200 illustrating the epipolar line-based feature aggregation in detailed architecture, according to one or more embodiments as disclosed herein. For each target location, the patches along the epipolar line are provided as input to the Epipolar Line based Transformer. The Aggregated output of the Epipolar Line based transformer is then provided as input to a Multi-Layer Perceptron (MLP). This is trained to output a scaling parameter for each target location's pixel. The scaled output is the output encoding of the Epipolar Based Feature Aggregation

FIG. 13 is an example diagram S1300 illustrating the object view feature aggregation in detailed architecture, according to one or more embodiments as disclosed herein. For each target location, the patches from the Epipolar Based Feature Transformer for each reference view is concatenated and given as input to the Object View Based Transformer.

The Aggregated output of the Object View based transformer is then provided as input to a Multi-Layer Perceptron (MLP). This is trained to output a scaling parameter for each target location's pixel. The scaled output encoding is given as input to the second MLP.

FIG. 14 is an example diagram S1400 illustrating the view feature extractor 510 along the 3D landmark generator 512, according to one or more embodiments as disclosed herein. The visual features are extracted on the generated image and matched with reference view. Typically matching with one reference image is sufficient but to ensure stable points, One or more embodiments are used to match with multiple reference views.

Once the 2D-2D matches are established for the predicted image, one or more embodiments herein then triangulate new 3D landmarks and also assign new descriptors to them. These new landmarks and their associations are then updated in the reference database (Map).

FIG. 15 is an example diagram S1500 illustrating re-localization in suspend/resume scenario using an AR headset, according to one or more embodiments as disclosed herein. Successfully relocalizing, generates new 3D Landmarks for novel views of the object. These new 3D landmarks are then used to obtain visual matches and then estimate pose of the viewpoint.

FIG. 16 is an example diagram S1600 illustrating scene occlusion, according to one or more embodiments as disclosed herein. As illustrated in FIG. 16, the majority of the scene is occluded due to dynamic objects. Conventional tracking approaches will lose tracking whereas the proposed approach with the help of predicted 3D landmarks and descriptors can still obtain matches.

The various actions, acts, blocks, steps, or the like in the flow charts S600 and S700 may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements shown can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

What is claimed is:

1. A method for estimating a pose in an Extended reality (XR) environment, the method comprising:
obtaining, by an XR device, a list of a plurality of three dimensional (3D) objects relevant to each position of the XR device;
detecting, by the XR device, a transition of the XR device from a first position to a second position, the first position and the second position being positions of the each position of the XR device;
extracting, by the XR device, at least one first set of objects from a real-world scene from the list of the plurality of 3D objects, at the first position of the XR device;
predicting, by the XR device, at least one second set of 3D objects, from the list of the plurality of 3D objects, at the second position of the XR device; and
estimating, by the XR device, the pose, which is at the second position of the XR device, using the at least one first extracted object at the first position and the at least one second predicted object at the second position of the XR device.

2. The method as claimed in claim 1, wherein estimating, by the XR device, the pose at the second position of the XR device, using the at least one first extracted object at the first position and the at least one second predicted object at the second position of the XR device comprises:
identifying positions, including at least one previously visited position, in reference to the first position of the XR device from a memory, the at least one previously visited position being of the each position of the XR device;
computing an embedding vector for each of the identified positions, including the at least one previously visited position, by accumulating the visual information at a particular position;
aggregating the computed embedding vectors from each of the identified positions;
generating an image for the second position of the XR device using the aggregated information;
generating at least one 3D object at the second position of the XR device by correlating the generated image with the memory; and
estimating the pose of the second position of the XR device using the generated 3D object.

3. The method as claimed in claim 1, wherein estimating, by the XR device, the pose at the second position of the XR device, using the at least one first extracted object at the first position and the at least one second predicted object at the second position of the XR device comprises:
generating an image for the second position using accumulated information of reference views;
detecting at least one visual feature from the generated image;
extracting at least one descriptor associated with the at least one detected visual feature;
matching the at least one detected visual feature along with at least one extracted descriptor of the at least one second predicted object at the second position of the XR device with a memory; and
estimating the pose at the second position of the XR device.

4. The method as claimed in claim 3, wherein generating the image for the second position using the accumulated information of the reference views comprises:
aggregating patches along an epipolar line of a target location at the first position;
using a transformer to aggregate information along the epipolar line, wherein the transformer is trained to attend along the epipolar line;
generating an embedding vector of the aggregated epipolar patches;
accumulating information along the reference views; and
generating the image for the second position using the accumulated information of the reference views.

5. The method as claimed in claim 4, wherein the transformer aggregates the information across the reference views.

6. The method as claimed in claim 1, wherein obtaining, by the XR device, the list of the plurality of 3D objects relevant to the each position of the XR device comprises:
detecting at least one location of a 3D object of the plurality of 3D objects;
matching the 3D object across the each position of the XR device;
mapping the plurality of 3D objects relevant to each position of the XR device using matched locations; and
obtaining the list of the plurality of 3D objects relevant to the each position of the XR device based on the mapping.

7. The method as claimed in claim 1, wherein obtaining, by the XR device, the list of the plurality of 3D objects relevant to the each position of the XR device comprises:
determining, by the XR device, a plurality of positions associated with the XR device in a XR scene, the plurality of positions comprising the first position and the second position;
determining, by the XR device, a plurality of three dimensional (3D) objects in a real-world scene; and
obtaining, by the XR device, the list of the plurality of 3D objects relevant to the each position of the XR device.

8. The method as claimed in claim 7, wherein at least some of the plurality of positions are previously visited positions by the XR device in a same scene of the real-world scene.

9. The method as claimed in claim 1, wherein the at least one second set of 3D objects is at least one partially visible second set of 3D objects in an XR scene of the real-world scene, and wherein the at least one second set of 3D objects, from the list of the plurality of 3D objects, at the second position of the XR device is predicted by the XR device based on the XR device determining that the XR device is not able to view the at least one second set of 3D objects in the XR scene.

10. The method as claimed in claim 7, wherein the plurality of positions associated with the XR device in the XR scene is determined by using at least one sensor, and wherein the objects from the real-world scene are determined by using the at least one sensor.

11. A method for estimating a pose in an Extended reality (XR) environment by an XR device, the method comprising:
receiving a first image frame of a real-world scene around an XR device using at least one sensor of the XR device;
detecting a motion of the XR device subsequent to receiving the first image frame using the at least one sensor of the XR device;
identifying, in response to the detected motion, at least one three dimensional (3D) landmark of objects present in the first image frame of the real-world scene; and
predicting at least one new 3D landmark of objects present in a second image frame of the real world scene, by correlating the identified at least one 3D landmark and the detected motion with a memory.

12. The method as claimed in claim 11, wherein the method further comprises estimating the pose of the XR device corresponding to the second image frame using both the identified at least one 3D landmark and the predicted at least one new 3D landmark.

13. The method as claimed in claim 11, wherein the memory stores information representing the one or more previously identified objects and corresponding 3D landmarks of objects, including the identified at least one 3D landmark, in the real-world scene.

14. An XR device, comprising:
a processor;
a memory; and
an XR content controller, coupled with the processor and the memory, configured to:
obtain a list of a plurality of three dimensional (3D) objects relevant to each position of the XR device;
detect a transition of the XR device from a first position to a second position, the first position and the second position being positions of the each position of the XR device;
extract at least one first set of objects from a real-world scene from the list of the plurality of 3D objects, at the first position of the XR device;
predict at least one second set of 3D objects, from the list of the plurality of 3D objects, at the second position of the XR device; and
estimate the pose, which is at the second position of the XR device, using the at least one first extracted object at the first position and the at least one second predicted object at the second position of the XR device.

15. The XR device of claim 14, wherein the processor is configured to:
identify positions, including at least one previously visited position, in reference to the first position of the XR device from the memory, the at least one previously visited position being of the each position of the XR device;
compute an embedding vector for each of the identified positions, including the at least one previously visited position, by accumulating the visual information at a particular position;
aggregate the computed embedding vectors from each of the identified positions;
generate an image for the second position of the XR device using the aggregated information;
generate at least one 3D object at the second position of the XR device by correlating the generated image with the memory; and
estimate the pose of the second position of the XR device using the generated 3D object.

16. The XR device of claim 14, wherein the processor is configured to:
generate an image for the second position using accumulated information of reference views;
detect at least one visual feature from the generated image;
extract at least one descriptor associated with the at least one detected visual feature;
match the at least one detected visual feature along with at least one extracted descriptor of the at least one second predicted object at the second position of the XR device with the memory; and
estimate the pose at the second position of the XR device.

17. The XR device of claim 16, wherein the processor is configured to:
aggregate patches along an epipolar line of a target location at the first position;
use a transformer to aggregate information along the epipolar line, wherein the transformer is trained to attend along the epipolar line;
generate an embedding vector of the aggregated epipolar patches;
accumulate information along the reference views; and
generate the image for the second position using the accumulated information of the reference views.

18. The XR device of claim 17, wherein the transformer aggregates the information across the reference views.

19. The XR device of claim 14, wherein the processor is configured to:
detect at least one location of a 3D object of the plurality of 3D objects;
match the 3D object across the each position of the XR device;
map the plurality of 3D objects relevant to each position of the XR device using matched locations; and
obtain the list of the plurality of 3D objects relevant to the each position of the XR device based on the mapping.

20. The XR device of claim 14, wherein the processor is configured to:
determine a plurality of positions associated with the XR device in a XR scene, the plurality of positions comprising the first position and the second position;
determine a plurality of three dimensional (3D) objects in a real-world scene; and
obtain the list of the plurality of 3D objects relevant to the each position of the XR device.
